(19) United States
(12) Patent Application Publication
(10) Pub. No.: US 2020/0210599 A1
(43) Pub. Date: Jul. 2, 2020

(54) OpenDash System For Managing A Plurality Of Software Services Including Within A Cyber Range

(71) Applicants: Victor Akers, Scottsdale, AZ (US); Scott Wells, Queen Creek, AZ (US)

(72) Inventors: Victor Akers, Scottsdale, AZ (US); Scott Wells, Queen Creek, AZ (US)

(73) Assignee: Ultimate Knowledge Corporation, Scottsdale, AZ (US)

(21) Appl. No.: 16/732,196

(22) Filed: Dec. 31, 2019

Related U.S. Application Data
(60) Provisional application No. 62/787,167, filed on Dec. 31, 2018.

(51) Int. Cl. G06F 21/60; G06F 21/31; H04L 12/58; G06Q 10/10; G06F 9/54

(52) U.S. Cl. CPC G06F 21/604; G06F 21/31; G06F 9/54; G06Q 10/1093; H04L 51/02

(57) ABSTRACT

The present invention was created with the goal of uniting disparate applications into a single dashboard having a single user experience or interface—in other words, uniting disparate applications into a single pane of glass. The system is used to manage a plurality of software services and includes: a range management interface for creating and managing one or more roles, for assigning one or more application privileges to each role, for assigning one or more permissions to each of the one or more privileges, and for assigning one or more persons to each of the one or more roles; a user messaging interface for facilitating direct communications between the one or more persons; an event calendar for visualizing time sensitive events; a system-wide alert functionality for providing one or more alerts to all persons associated with the system; and a software integrations interface for adding one or more applications that are managed by the range management interface. Methods for creating one or more roles, methods for registering applications with the system, and methods for creating and displaying a dashboard are also provided that may be utilized within the system for managing a plurality of software services.

### BRIEF DESCRIPTION OF THE INVENTION

The present invention is generally related to managing a plurality of software services, and more particularly related to systems and methods for role-based management of a plurality of software services including the role-based management of a plurality of software services within a cyber range. By utilizing the herein disclosed system and associated methods, a user such as a range administrator can create and manage a plurality of roles than can be assigned to various persons associated with the system, can assign various applications to each role, and can assign various permissions for how the each role can utilize assigned applications.

The present invention was created with the goal of uniting disparate applications into a single dashboard having a single user experience or interface—in other words, into a single pane of glass. The herein disclosed system may be a microservice based application that can allow vendor functionality to be integrated into a common framework having a common user dashboard. The system can provide an extremely scalable infrastructure having containerized docker services than can be orchestrated with popular options like Docker Swarm, Kubernetes, and RH OpenShift, for example. The herein disclosed system may utilize an Open Micro Services Enterprise Framework to provide a foundation in which multiple applications can share data, processes, and/or services within a single system such as a cyber range.

In an exemplary embodiment, the system for managing a plurality of software services includes: a range management interface for creating and managing one or more roles, for assigning one or more application privileges to each role, for assigning one or more permissions to each of the one or more privileges, and for assigning one or more persons to each of the one or more roles; a user messaging interface for facilitating direct communications between the one or more persons; an event calendar for visualizing time sensitive events; a system-wide alert functionality for providing one or more alerts to all persons associated with the system; and a software integrations interface for adding one or more applications that be managed by the range management interface.

In a preferred embodiment, the system for managing a plurality of software services includes a role creation process having the following steps: receiving a definition of a role from a user; creating the role based upon the definition; receiving a selection of one or more applications from the user to be associated with the role as one or more privileges for the role; assigning the one or more privileges to the role; receiving one or more permissions from the user to be associated with the one or more privileges; assigning the one or more permissions to the one or more privileges; receiving a selection of one or more persons to be associated with the role; and assigning the one or more persons to the role.

The process of adding or associating additional software to the system involves an application registration process for registering a software application as being appropriate for use in the system (a cyber range, for example). An application registration process includes the steps of: receiving a selection of an application to be added to a range environment; determining whether the application adheres to an open microservice enterprise framework architecture and provides one or more microservices that may be called individually; registering the application in a range app store so that the application may be utilized through a dashboard visible to persons based upon a role; and registering the application in an open microservice enterprise framework to facilitate sharing data between applications.

The process of creating (or building) a dashboard for a user includes the steps of: receiving a set of log-in identifiers from a person; identifying the person based upon the set of log-in identifiers and recognizing the person as having a role; creating the dashboard of one or more authorized applications assigned to the role; and displaying the dashboard to the person and thus facilitating the person's ability to utilize the one or more authorized applications according to the role. In certain embodiments, it may be possible for user to switch to a different role within the system. For example, a user may be assigned to two or more roles and may have an ability (or a functionality) to switch from a first role to a second role.

The herein disclosed system for managing a plurality of software services may, in certain embodiments, include framework extensibility providing an ability to extend core functionality by the use of custom web elements plugged into the element's framework JSON (JavaScript Object Notation) definition. Thus, the core functionality (such as Identity Management, for example) can be extended to include a management interface to disparate system management functionality. Furthermore, disparate but related activity and tracking information can be aggregated and/or consolidated into a single presentation platform such as a dashboard as discussed herein.

While the present invention is preferably used to manage a plurality of software services within a cyber range, the herein disclosed systems and methods can be advantageously applied to other systems, such as other types of enterprise software systems. The present disclosure, therefore, is not intended to be limited to use with cyber ranges but is instead intended to include all possible uses including for non-cyber range systems.

### CROSS-REFERENCES TO RELATED APPLICATIONS

This non-provisional utility application takes priority to the previously filed provisional application: Application No. 62/787,167, filed Dec. 31, 2018, which is hereby incorporated in its entirety by reference.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

A cyber range is a controlled virtual environment. Cyber ranges provide secure environments that may be isolated from other systems and monitored during use. Cyber ranges are used for cybersecurity education, training, and testing to allow cyber professionals, students, instructors, and trainees to hone their security skills in a highly controlled environment that is complete isolated from real world systems.

The cyber range marketplace is growing at a feverish pace each year. The number of software products and applications supporting these cyber ranges continues to grow and expand as the use of cyber ranges becomes more widespread and therefore the demand for a diverse spectrum of cyber range functionalities increases.

But the use of a plurality of software services within a single cyber range can be problematic. If applications from several dissimilar vendors are added to a customer's cyber range, any disparities between the applications can become pronounced when persons attempt to use the differing applications. The persons associated with the cyber range, such as administrators, event planners, and participants, may be forced to use a multitude of applications each having a different user experience and/or a differing user interface. In this situation, the cyber range may become nothing more than an environment of different applications and utilities—a far cry from the goal of providing a secure cyber environment with a rich spectrum of integrated functionalities.

It would therefore be advantageous to provide a system to unify disparate applications into a single integrated system having a common dashboard and thus providing a smoother user experience. In this way, a user's portal or dashboard may be populated with the appropriate applications assigned to that user, and the user can call the functions of the vendor application from within the same portal or dashboard. In other words, the disparate applications may be unified into a single pain of glass providing a cohesive user experience.

### BRIEF DESCRIPTION OF THE SEVERAL VIEWS OF THE DRAWING

FIG. 1 includes a flow diagram illustrating a general overview of the herein disclosed methods for creating and displaying a dashboard for facilitating a person's ability to utilize one or more authorized applications within a range, in accordance with an exemplary embodiment of the present invention (the methods may be carried out by the herein disclosed system for managing a plurality of software services);

FIG. 2 includes a flow diagram illustrating a general overview of the herein disclosed methods for creating and managing one or more roles within a system for managing a plurality of software services, in accordance with an exemplary embodiment of the present invention (the methods may be carried out by the herein disclosed system for managing a plurality of software services);

FIG. 3 includes an exemplary illustration of a dashboard of the herein disclosed system for managing a plurality of software services, in accordance with a preferred embodiment of the present invention;

FIG. 4 includes an exemplary screenshot of a dashboard of the herein disclosed system for managing a plurality of software services, illustrating an option to switch from a first role to a second role, in accordance with a preferred embodiment of the present invention;

FIG. 5 illustrates an exemplary method for logging in a person to the herein disclosed system for managing a plurality of software services, in accordance with an exemplary embodiment of the present invention;

FIG. 6 illustrates an exemplary method for registering an application for use within the herein disclosed system for managing a plurality of software services, in accordance with an exemplary embodiment of the present invention; and

FIG. 7 illustrates a preferred method for creating and managing one or more roles within a system for managing a plurality of software services, in accordance with an exemplary embodiment of the present invention.

### DETAILED DESCRIPTION OF THE INVENTION

Throughout this specification reference is made to one or more users of the system. The term user is intended to include any and all possible persons or entities than may utilize the herein disclosed system or any of the associated methods. For example, a user may be a system administrator, a cyber range administrator, a trainee, an employee, a contractor, a business entity, a group of persons, or any other being capable of inputting data, indications, or selections into the system. In other words, the term user may refer both to an administrator who manages the plurality of software services and/or a person being trained on the system whose role is restricted to read-only use of certain applications, for example.

Also throughout this specification, reference is made to a range or one or more ranges. The term range is intended to include one or more cyber ranges, but the term is also intended to include other restricted systems or groups of restricted systems that are not cyber ranges. For example, a range may include an enterprise software system.

In an exemplary embodiment, the system for managing a plurality of software services includes: a range management interface for creating and managing one or more roles, for assigning one or more application privileges to each role, for assigning one or more permissions to each of the one or more privileges, and for assigning one or more persons to each of the one or more roles; a user messaging interface for facilitating direct communications between the one or more persons; an event calendar for visualizing time sensitive events; a system-wide alert functionality for providing one or more alerts to all persons associated with the system; and a software integrations interface for adding one or more applications that are managed by the range management interface. In a preferred embodiment, the system for managing a plurality of software service further includes an application programming interface for testing one or more API calls.

The user messaging interface can allow restrictions on the use or viewing of certain communications. Messages can be restricted based upon a role of a person, or based upon a group of persons or roles, for example. Or direct communication can be restricted for certain roles or between certain roles.

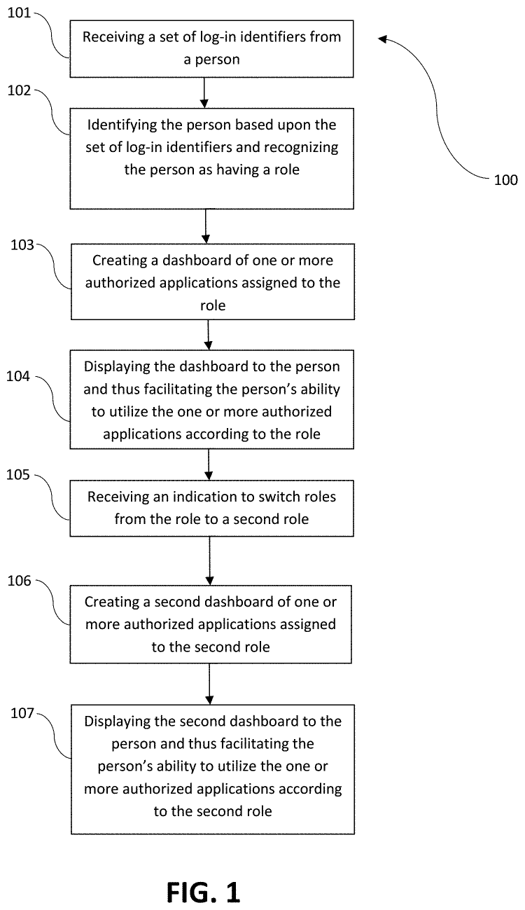

Referring to FIG. 1, a flow diagram illustrating an embodiment of method 100 for creating and displaying a dashboard for facilitating a person's ability to utilize one or more authorized applications with a range is shown. Method 100 includes step 101 receiving a set of log-in identifiers from a person; step 102 identifying the person based upon the set of log-in identifiers and recognizing the person as having a role; step 103 creating the dashboard of one or more authorized applications assigned to the role; step 104 displaying the dashboard to the person and thus facilitating the person's ability to utilize the one or more authorized applications according to the role; step 105 receiving an indication to switch roles from the role to a second role; step 106 creating a second dashboard of one or more authorized applications assigned to the second role; and step 107 displaying the second dashboard to the person and thus facilitating the person's ability to utilize the one or more authorized applications according to the second role. In certain embodiments, step 105, step 106, and step 107 may not be functional if a person (or other user) is assigned to only a single role or if a system administrator has restricted the ability of persons or other users to switch roles.

Step 101 receiving a set of log-in identities from a person may include a credential or identification evaluating service or functionality, such as KeyCloak for example. The set of log-in identifies can include any information, password, pass code, or numeric code, as is known in the art, but in a preferred embodiment the set of log-in identifiers includes a username to identify the person and a password as a security measure. The herein disclosed system may be utilized with small or medium sized installations or with larger enterprise federated installations through the selective use of open source and/or proprietary identification methodologies.

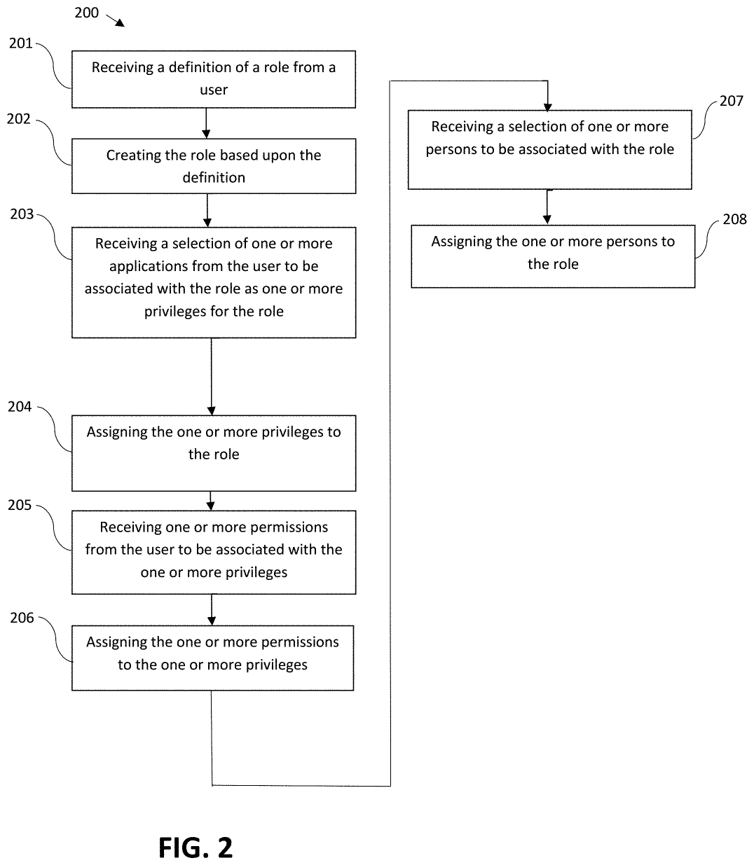

Referring to FIG. 2, a flow diagram illustrating an embodiment of a method for creating and managing one or more roles within a system for managing a plurality of software services is shown. Method 200 for creating and managing one or more roles includes: step 201 receiving a definition of a role from a user; step 202 creating the role based upon the definition; step 203 receiving a selection of one or more applications from the user to be associated with the role as one or more privileges for the role; step 204 assigning the one or more privileges to the role; step 205 receiving one or more permissions from the user to be associated with the one or more privileges; step 206 assigning the one or more permissions to the one or more privileges; step 207 receiving a selection of one or more persons to be associated with the role; and step 208 assigning the one or more persons to the role.

Step 203 receiving a selection of one or more applications from the user to be associated with the role involves the user making a selection of applications that that particular role will have access to. The access may be referred to as a privilege, meaning that the role has a privilege to use the application.

Step 205 receiving one or more permissions from the user to be associated with the one or more privileges involves the user making a selection of particular functionalities or applets from within an application. An applet is one functionality of a larger application that may have a plurality of functionalities. For example, the user may grant a privilege to a particular role to use an application but may restrict this privilege to only particular applets within that application. The term permission as used herein refers to a right to use an applet (or a functionality), as opposed to the term privilege which refers to a right to use an application.

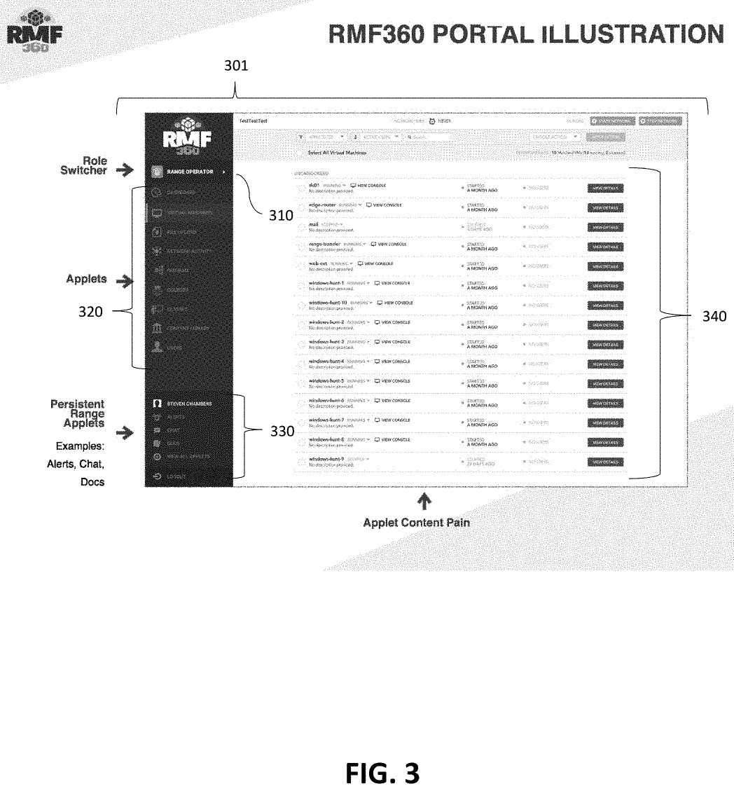

Referring to FIG. 3, an exemplary illustration of an exemplary dashboard is shown. Dashboard 301 may be created through dashboard creation process 100 as illustrated in FIG. 1. Dashboard 301 includes role identification 310, display of associated applets or functionalities 320, persistent range functionalities 330, and applet content 340. Role identification 310 may list a particular role that the user or person has been assigned to. In certain embodiments, role identification 310 may include a role switch button (which may be referred to as a role switcher button or functionality) to allow the user or person to switch between a first role to one of the other available or assigned roles. Applet content 340 provides any type of data, information, or content that is available or associated with the particular applet currently selected at display of associated applets or functionalities 320.

Persistent range functionalities 330 includes one or more functionalities than are available to users or persons across the entire system (or the entire cyber range, for systems utilized with a cyber range). Persistent range functionalities 330 may include a user messaging interface, an event calendar, a system-wide alert, one or more electronic documents, for example.

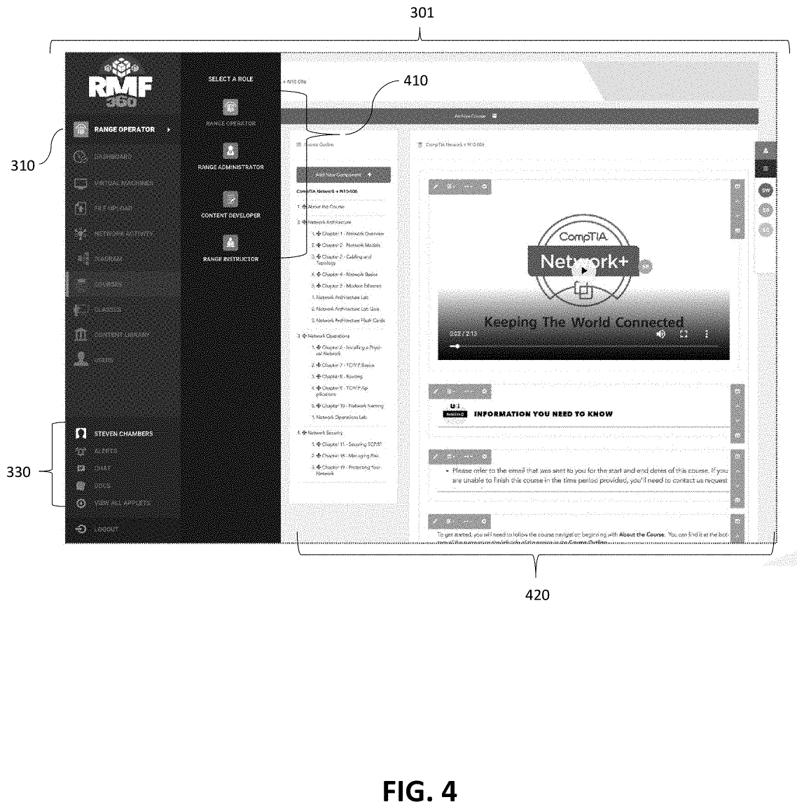

Referring to FIG. 4, an exemplary illustration of dashboard 301 is shown to illustrate role switcher option 410. In this embodiment, a user has selected role identification 310 and is now presented with options for switching roles from the current role (a first role) to a second role. In the example illustrated in FIG. 4, the user or person may switch from a Range Operator to a Range Administrator, a Content Developer, or a Range Instructor. Role content 420 displays one or more items of information relevant to the role selected at role switcher option 410.

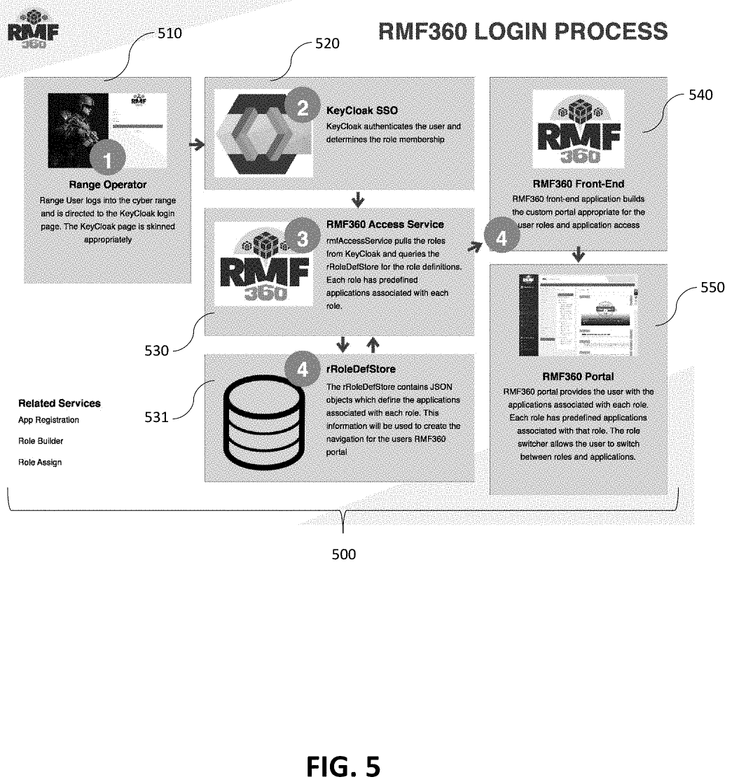

Referring to FIG. 5, an exemplary methodology for logging in a person to the herein disclosed system for managing a plurality of software services is shown. Method 500 for logging in a person or user includes step 510 receiving a set of log-in identifiers from a user, step 520 authenticating the user and determining one or more roles that the user is associated with, step 530 utilizing the one or more roles determined in step 520 to pull one or more role definitions and one or more applications associated with the one or more roles from a role definition store (communication with the role definition store is step 531), step 540 building a custom portal for the user based upon the role and application access, step 550 providing the custom portal as a dashboard providing the user access to the applets and/or applications associated with the role.

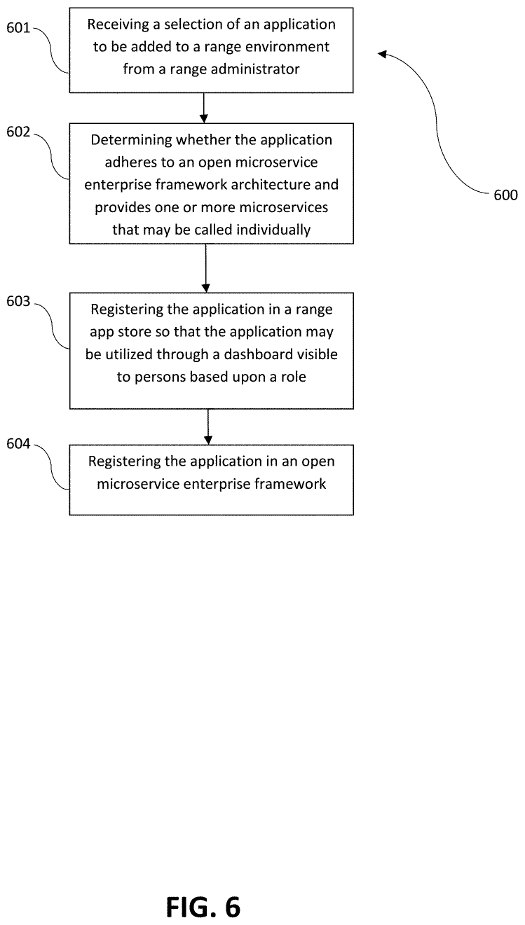

Referring to FIG. 6, an exemplary methodology for registering an application for use with the herein disclosed system for managing a plurality of software services is shown. Method 600 allows a range administrator (who may be referred to as a system administrator or a user) to build (or add to) a group or set of applications that may be utilized with the system or range. Method 600 includes step 601 receiving a selection of an application to be added to a range environment from a range administrator, step 602 determining whether the application adheres to an open microservice enterprise framework architecture and provides one or more microservices that may be called individually, step 603 registering the application in a range app store so that the application may be utilized through a dashboard visible to persons based upon a role, and step 604 registering the application in an open microservice enterprise framework so that data may be shared between applications.

Step 602 involves determining whether the application is appropriate to be added to the system. In certain embodiments, if the application does not adhere to an open microservice enterprise framework architecture then it cannot be added to the system and/or registered with the range app store. Also in certain embodiments, if the application does not provide one or more microservices that may be individually called then it cannot be added to the system and/or registered with the range app store. The range app store may contain JSON (JavaScript Object Notation) objects which detail the applications registered on the range.

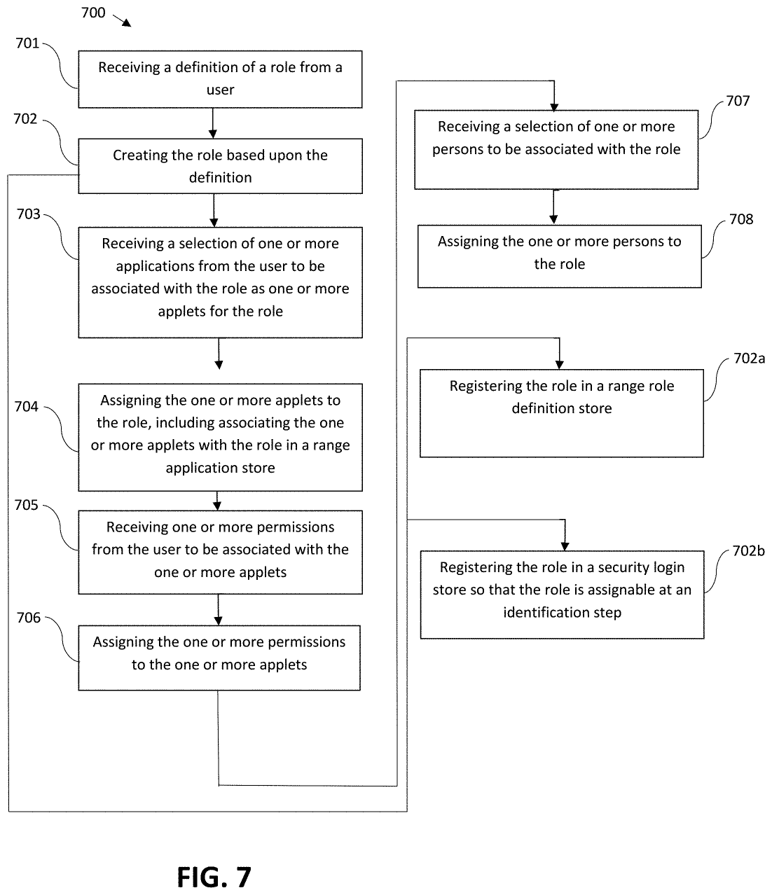

Referring to FIG. 7, a preferred method for creating and managing one or more roles within a system for managing a plurality of software services is shown. Method 700 is similar to method 200 illustrated in FIG. 2, and is a preferred alternative embodiment to method 200. Method 700 includes step 701 receiving a definition of a role, step 702 creating the role based upon the definition, step 702a registering the role in a range role definition store, step 702b registering the role in a security login store so that the role is assignable at an identification step, step 703 receiving a selection of one or more applications from the user to be associated with the role as one or more applets for the role, step 704 assigning the one or more applets to the role, including associating the one or more applets with the role in a range app store (which may be referred to as a range application store, or a system application store), step 705 receiving one or more permissions from the user to be associated with the one or more applets, step 706 assigning the one or more permission to the one or more applets, step 707 receiving a selection of one or more persons to be associated with the role, and step 708 assigning the one or more persons to the role.

While the present invention has been illustrated and described herein in terms of a preferred embodiment and several alternatives, it is to be understood that the devices, apparatus, systems, and methods described herein can have a multitude of additional uses and applications. Accordingly, the invention should not be limited to just the particular description and various drawing figures contained in this specification that merely illustrate a preferred embodiment and application of the principles of the invention.

Furthermore, it should be apparent that the examples discussed above are only presented as examples. The various user-accessible menus, buttons, and interfaces are only one way to accomplish the more generally described systems, methods, apparatuses, computer programs, and software as a service offerings. Finally, it should be noted that where this specification describes a system for managing a plurality of software services, it is intended to cover related methods for managing a plurality of software services, related apparatuses for managing a plurality of software services, related computer programs managing a plurality of software services, and related software offered as a service for managing a plurality of software services. For example, an apparatus for managing a plurality of software services would be comprised of a central processing unit (CPU) containing code for the managing of a plurality of software services tasks that is capable of processing user-input options, one or more input devices such as a keyboard and mouse, and a display screen.

What is claimed is:

1. A system for managing a plurality of software services, comprising:
a range management interface for creating and managing one or more roles, for assigning one or more application privileges to each role, for assigning one or more permissions to each of the one or more privileges, and for assigning one or more persons to each of the one or more roles;
a user messaging interface for facilitating direct communications between the one or more persons;
an event calendar for visualizing time sensitive events;
a system-wide alert functionality for providing one or more alerts to all persons associated with the system; and
a software integrations interface for adding one or more applications that may be managed by the range management interface.

2. The system for managing a plurality of software services as recited in claim 1, further comprising:
an application programming interface for testing one or more API calls.

3. The system for managing a plurality of software services as recited in claim 1, wherein the user messaging interface provides role-based moderation for group chats between one or more persons.

4. The system for managing a plurality of software services as recited in claim 1, wherein the user messaging interface provides an ability to restrict direct communications based upon the one or more roles.

5. The system for managing a plurality of software services as recited in claim 1, wherein the range management interface carries out one or more steps of a role creation process.

6. The system for managing a plurality of software services as recited in claim 5, wherein the role creation process includes the steps of:
receiving a definition of a role from a user;
creating the role based upon the definition;
receiving a selection of one or more applications from the user to be associated with the role as one or more privileges for the role;
assigning the one or more privileges to the role;
receiving one or more permissions from the user to be associated with the one or more privileges;
assigning the one or more permissions to the one or more privileges;
receiving a selection of one or more persons to be associated with the role; and
assigning the one or more persons to the role.

7. The system for managing a plurality of software services as recited in claim 5, wherein the role creation process includes the steps of:
receiving a definition of a role from a user;
creating the role based upon the definition;
registering the role in a range role definition store;
registering the role in a security login store so that the role is assignable at an identification step;
receiving a selection of one or more applications from the user to be associated with the role as one or more applets for the role;
assigning the one or more applets to the role, including associating the one or more applets with the role in a range application store;
receiving one or more permissions from the user to be associated with the one or more applets;
assigning the one or more permissions to the one or more applets;
receiving a selection of one or more persons to be associated with the role; and
assigning the one or more persons to the role.

8. The system for managing a plurality of software services as recited in claim 1, wherein the event calendar pushes notifications to a user alert panel that is part of a role-based dashboard.

9. The system for managing a plurality of software services as recited in claim 1, wherein the software integrations interface includes an application registration process.

10. The system for managing a plurality of software services as recited in claim 9, wherein the application registration process includes the steps of:
receiving a selection of an application to be added to a range environment;
determining whether the application adheres to an open microservice enterprise framework architecture and provides one or more microservices that may be called individually;
registering the application in a range app store so that the application may be utilized through a dashboard visible to persons based upon a role; and
registering the application in an open microservice enterprise framework.

11. The system for managing a plurality of software services as recited in claim 1, wherein the system is utilized for managing a plurality of software services within a cyber range.

12. The system for managing a plurality of software services as recited in claim 1, wherein the system is accessible through a dashboard and wherein the dashboard is created and displayed through a dashboard creation process including the steps of:
receiving a set of log-in identifiers from a person;
identifying the person based upon the set of log-in identifiers and recognizing the person as having a role;
creating the dashboard of one or more authorized applications assigned to the role; and
displaying the dashboard to the person and thus facilitating the person's ability to utilize the one or more authorized applications according to the role.

13. The system for managing a plurality of software services as recited in claim 12, wherein the dashboard creation process further includes the steps of:
receiving an indication to switch roles from the role to a second role;
creating a second dashboard of one or more authorized applications assigned to the second role; and
displaying the second dashboard to the person and thus facilitating the person's ability to utilize the one or more authorized applications according to the second role.

14. A method for creating and displaying a dashboard for facilitating a person's ability to utilize one or more authorized applications, comprising the steps of:
receiving a set of log-in identifiers from a person;
identifying the person based upon the set of log-in identifiers and recognizing the person as having a role;
creating the dashboard of one or more authorized applications assigned to the role;
displaying the dashboard to the person and thus facilitating the person's ability to utilize the one or more authorized applications according to the role;
receiving an indication to switch roles from the role to a second role;
creating a second dashboard of one or more authorized applications assigned to the second role; and
displaying the second dashboard to the person and thus facilitating the person's ability to utilize the one or more authorized applications according to the second role.

15. The method for creating and displaying a dashboard for facilitating a person's ability to utilize one or more authorized applications as recited in claim 14, wherein the method is utilized for a cyber range.

16. A method for creating and managing one or more roles within a system for managing a plurality of software services, comprising the steps of:
receiving a definition of a role from a user;
creating the role based upon the definition;
registering the role in a range role definition store;
registering the role in a security login store so that the role is assignable at an identification step;
receiving a selection of one or more applications from the user to be associated with the role as one or more applets for the role;
assigning the one or more applets to the role, including associating the one or more applets with the role in a range application store;
receiving one or more permissions from the user to be associated with the one or more applets;
assigning the one or more permissions to the one or more applets;
receiving a selection of one or more persons to be associated with the role; and
assigning the one or more persons to the role.

17. The method for creating and managing one or more roles within a system for managing a plurality of software services as recited in claim 16, wherein the method is utilized for a cyber range.

18. A method for registering an application for use within a system for managing a plurality of software services, comprising the steps of:
receiving a selection of an application to be added to an environment;
determining whether the application adheres to an open microservice enterprise framework architecture and provides one or more microservices that may be called individually;
registering the application in a range app store so that the application may be utilized through a dashboard visible to persons based upon a role; and
registering the application in an open microservice enterprise framework.

19. The method for registering an application for use within a system for managing a plurality of software services as recited in claim 18, wherein the method is utilized for a cyber range.
